(19) United States
(12) Patent Application Publication
(10) Pub. No.: US 2023/0201643 A1
(43) Pub. Date: Jun. 29, 2023

(54) FIRE PROTECTION APPARATUS FOR BATTERY SYSTEM USING LATENT HEAT OF PHASE CHANGE MATERIAL AND BATTERY SYSTEM INCLUDING THE SAME

(71) Applicant: INNODEUS CO., LTD., Seoul (KR)

(72) Inventor: Kwang Seob KIM, Seoul (KR)

(73) Assignee: INNODEUS CO., LTD., Seoul (KR)

(21) Appl. No.: 17/927,873

(22) PCT Filed: Apr. 29, 2021
(86) PCT No.: PCT/KR2021/005413

§ 371 Date: Nov. 26, 2022

(30) Foreign Application Priority Data
Jun. 5, 2020 (KR) 10-2020-0068576

(51) Int. Cl. A62C 3/16; A62C 35/13; H01M 50/383

(52) U.S. Cl. CPC A62C 3/16; A62C 35/13; H01M 50/383

(57) ABSTRACT

The present disclosure relates to a fire protection apparatus for a battery system using latent heat of a phase change material and a battery system including the same. The fire protection apparatus includes partition walls configured to partition batteries, each formed to have an accommodation space filled with heat absorption-heat dissipation means therein, and configured to isolate the entire space in which the batteries are installed from the outside, and the heat absorption-heat dissipation means provided in the accommodation space of the partition wall and configured to absorb and discharge heat attributable to the thermal runaway of an accident battery.

### BACKGROUND

### 1. Technical Field

The present disclosure relates to a fire protection apparatus for a battery system using latent heat of a phase change material and a battery system including the same, and more particularly, to a fire protection apparatus for a battery system using latent heat of a phase change material, which can prevent a fire by suppressing a rise in a surrounding temperature, which is attributable to the generation of heat of an accident battery, in a way to effectively absorb and discharge the heat and thus can prevent a secondary accident of an adjacent normal battery and a surrounding facility, in a battery system including the accident battery attributable to thermal runaway, and a battery system including the same.

### 2. Related Art

As the use of electrical goods is increased due to the continuous development of the industry and an increase in income, the amount of electricity used tends to rapidly increase. In the summer season in which coolers are commonly used or the winter season in which warmers are commonly used, a major blackout frequently occurs due to a sudden increase in the amount of electricity used.

There is a growing voice of increasing facilities for power supply in order to handle such a continuous increase in the load. If power facilities are increased in order to handle a maximum load, however, a capacity factor is reduced because idle facilities in a season except the summer and winter seasons are increased, and there is a monetary problem according to the increase and maintenance of the power facilities.

A battery system, that is, one of solutions for solving such a problem, is an energy storage system (hereinafter abbreviated as an “ESS”). The ESS is a system for maximizing energy efficiency by storing generated power in an association system that includes a power station, a substation, and a transmission line and selectively using power in a season that requires power.

If the ESS is used, power can be efficiently used through load leveling by which idle power is stored at nighttime and stored power is used in the daytime that requires much power consumption. If the ESS is combined with a smart grid, energy efficiency can be increased because the information technology (IT) is applied to the existing power network, a power supplier and a power consumer exchange real-time information bi-directionally, and electric energy is supplied in a season requiring power through the ESS.

In the ESS, the most important element is an energy storage technology, and a battery is basically used. The battery that is used in the ESS consists of many cells, not one cell. The cells are gathered to form a module. The modules are gathered to form a pack. The packs are gathered to form a rack. Finally, several racks are gathered to form a system.

An ESS battery rack that is necessary to construct such a system has a structure in which battery modules having a pack form are stacked and received. In general, a safety apparatus for preventing damage to the battery module is constructed in the ESS battery rack.

Recently, the demand for the ESS is explosively increased due to the upsurge of interest in new renewable energy. Attention is also concentrated on the safety of the battery and the rack that constitute the ESS.

A lithium ion battery is basically used as an energy charging battery that is used in the ESS.

The lithium ion battery is a chemical storage device in which lithium ions are stored and discharged while alternating between an anode and a cathode. The lithium ion battery can be rapidly charged compared to other types of batteries, and can be used for a long time due to high output density. Furthermore, the lithium ion battery is relatively small and light. If the lithium ion battery is charged without being fully discharged, the lithium ion battery does not have a memory effect in which a driving time is more reduced than an original driving time. Furthermore, the lithium ion battery is eco-friendly and requires a relatively low maintenance and repair cost. However, the lithium ion battery has a disadvantage in that it is vulnerable to a fire compared to other batteries.

A fire in the battery chiefly occurs due to a thermal runaway phenomenon of a battery cell.

The thermal runaway phenomenon refers to a chemical reaction in which a high-degree oxidative anode and a high-degree reductive cathode meet and autonomously generate heat very quickly.

When the thermal runaway phenomenon occurs, a battery cell discharges energy stored therein very rapidly. As energy stored in the battery cell increases, a thermal runaway reaction becomes more active. In particular, in the case of the lithium ion battery, the thermal runaway phenomenon is very active due to because the lithium ion battery has higher energy density than other batteries. The causes of the thermal runaway phenomenon include overcharging, overdischarging, an internal short circuit, a poor terminal contact, and poor charging.

In general, when a temperature within the lithium ion battery is 170° C. or more, thermal runaway occurs. If an environment that is conducive to the generation of heat even in a state of 70° C. or less is formed, thermal runaway occurs after one or two days. When thermal runaway phenomenon occurs, internal pressure of the lithium ion battery is increased, and an electrolyte solution within the lithium ion battery is vaporized. Thereafter, the lithium ion battery is expanded, the electrolyte solution is erupted, and white smoke is produced from the lithium ion battery. The lithium ion battery begins to burn when a temperature within the lithium ion battery is 600° C. or more.

A fire occurring due to the thermal runaway phenomenon continues until energy stored in the battery is fully discharged although oxygen necessary for combustion is blocked. A large amount of toxic gas, such as carbon monoxide (CO) and acetylene (C2H2), is discharged along with the fire. The thermal runaway phenomenon may occur due to overcharge or over discharging, an internal short circuit, a failure of a terminal, a concentration of an electrolyte solution, or a charging failure.

A battery module that is used in the ESS is produced by densely populating lithium ion battery cells in a pack. The battery modules included in stages are stacked up and down to form a storage form having a rack form. Since the battery racks are densely installed in a container and a room, a fire in the battery module is likely to spread as a large fire of the ESS.

When thermal runaway occurs due to the occurrence of an accident in a specific battery system as described above, a temperature within an accident cell and a surrounding temperature suddenly rise, and gas is erupted from the accident cell. At this time, a conventional fire system detects the occurrence of a fire by detecting the temperature and the gas, and operates several types of fire extinguishing systems.

However, in general, a window for a space in which the ESS is installed is not provided for a constant temperature and constant humidity. Accordingly, it is difficult to suppress a fire within the space on the outside. Although a fire extinguishing facility is installed within the space, there is a problem in that it is difficult to early suppress a fire because a temperature within the space is very high, that is, a maximum of 1100° C., when the fire occurs.

The international fire code (IFC) recommends guidelines for suppressing the spread of a fire by maintaining a constant separation distance depending on a battery capacity. In order to solve such a problem, there is proposed a method of setting a constant separation distance by moving an adjacent battery rack when a fire occurs in a specific battery rack. Such a method has a difficulty in that a battery rack having a significant volume and weight has to be moved, and is inevitably very vulnerable to an external influence, such as an earthquake, because it is difficult to fix the battery rack.

Conventional technologies are described. Korean Patent Application Publication No. 10-2001-0028777 (entitled “APPARATUS FOR FIRE PROOFING OF STATIC CONDENSER”) and Korean Patent No. 10-1706717 (entitled “FIRE PREVENTING DEVICE FOR BATTERY PACK OF ENERGY STORAGE SYSTEM”) are disclosed.

In the apparatus for the fire proofing of a static condenser, a fire is prevented from spreading to the inside of a battery rack by installing an interlayer diaphragm 12, an inter-cell diaphragm 21, and a reverse diaphragm 22 for fire prevention, which are made of a flame-retardant stainless steel material, in an interlayer battery installed in a plurality of layers. However, the apparatus has problems in that it does not prevent the spread of a fire to a normal battery adjacent to an accident battery and does not prevent the spread of a fire to the outside of the battery rack.

In the fire preventing device for a battery pack of an energy storage system, an interception block 600 is installed on one side of each of trays 110 that are arranged so that a plurality of battery modules is stacked up and down in a way that when a fire occurs in a battery module, the end of the interception block 600 enters the inside of the tray 110 and blocks the fire by partitioning the plurality of battery modules so that the fire is not spread to an adjacent battery module. However, the fire preventing device has problems in that an actuator 700 having a rod that moves the interception block 600 to the tray 110 greatly reduces a large ESS installation space, the structure of the fire preventing device is complicated, the battery module is not protected when a fire occurs outside an ESS battery rack because the one side of the tray 110 is opened, and toxic gas that is generated by the combustion of the battery module contaminates the ESS installation space.

### SUMMARY

Various embodiments are directed to a fire protection apparatus for a battery system using latent heat of a phase change material, which can prevent a fire by suppressing a rise in a surrounding temperature, which is attributable to the generation of heat of an accident battery, in a way to effectively absorb and discharge the heat and thus can prevent a secondary accident of an adjacent normal battery and a surrounding facility, in a battery system including the accident battery attributable to thermal runaway, and a battery system including the same.

In an embodiment, a fire protection apparatus for preventing a fire attributable to thermal runway of a battery in a battery system in which two or more batteries are adjacently constructed may include partition walls configured to partition batteries, each formed to have an accommodation space filled with heat absorption-heat dissipation means therein, and configured to isolate the entire space in which the batteries are installed from the outside, and the heat absorption-heat dissipation means provided in the accommodation space of the partition wall and configured to absorb and discharge heat attributable to the thermal runaway of an accident battery.

In an aspect of the present disclosure, all of the partition walls are configured to communicate with one another, and the heat absorption-heat dissipation means is made of a phase change material (PCM) and is made of a material a phase of which is changed at a temperature less than a temperature at which thermal runaway occurs.

In an aspect of the present disclosure, the heat absorption-heat dissipation means is at least any one of water (H₂O), a mixture of water, an antifreezing solution, and a mixture thereof.

In an aspect of the present disclosure, the fire protection apparatus further comprises a heat absorption-heat dissipation means inflow and outflow device configured to supply the heat absorption-discharge means to an internal space of the partition wall and to discharge the heat absorption-discharge means to an outside.

In an aspect of the present disclosure, the heat absorption-heat dissipation means inflow and outflow device comprises: an inlet formed on one side of the partition wall at an upper part thereof and through which the heat absorption-heat dissipation means is introduced; and an outlet formed on the other side of the partition wall at an upper part thereof and through which the heat absorption-heat dissipation means is discharged.

The fire protection apparatus further comprises: a temperature detection module configured to detect an inside and outside temperature of the partition wall; phase change material supply means configured to supply a phase change material through the inlet; a circulation outlet formed on one side at a bottom of the partition wall on the other side thereof; a one-way check valve provided in each of the inlet and the circulation outlet and opened and closed by control of a controller; and the controller configured to receive a temperature detected by the temperature detection module and to operate the phase change material supply means and the one-way check valve so that the phase change material is supplied through the inlet and the phase change material is discharged through the circulation outlet.

In an aspect of the present disclosure, the outlet and the circulation outlet are integrally formed.

According to another aspect of the present disclosure, a battery system comprising the fire protection apparatus, the fire protection apparatus for preventing a fire attributable to thermal runway of a battery in a battery system in which two or more batteries are adjacently constructed may include partition walls configured to partition batteries, each formed to have an accommodation space filled with heat absorption-heat dissipation means therein, and configured to isolate the entire space in which the batteries are installed from the outside, and the heat absorption-heat dissipation means provided in the accommodation space of the partition wall and configured to absorb and discharge heat attributable to the thermal runaway of an accident battery.

The fire protection apparatus for a battery system using latent heat of a phase change material and a battery system including the same according to embodiments of the present disclosure provide the following effects.

First, an embodiment of the present disclosure has an effect in that it can prevent a secondary accident of an adjacent normal battery and a surrounding facility by preventing a fire in a way to suppress a rise in a surrounding temperature, which is attributable to the generation of heat of an accident battery, by effectively absorbing and discharging the heat in a battery system including the accident battery attributable to thermal runaway.

Second, an embodiment of the present disclosure has effects in that it can serve versatility and economic feasibility because components for preventing a fire can be constructed relatively simply and a fire attributable to thermal runaway can be efficiently prevented.

Third, an embodiment of the present disclosure has an economical effect in that the fire protection apparatus can be reused even after performing a fire prevention function and maintenance and a repair thereof are simple.

### BRIEF DESCRIPTION OF THE DRAWINGS

FIG. 1 is a diagram schematically illustrating a fire protection apparatus for a battery system using latent heat of a phase change material according to the first embodiment of the present disclosure.

FIG. 2 is a graph illustrating a change in the state of water, that is, a phase change material, as heat absorption-heat dissipation means in the fire protection apparatus for a battery system using latent heat of a phase change material according to an embodiment of the present disclosure.

FIG. 3 is a diagram schematically illustrating another embodiment of the fire protection apparatus for a battery system using latent heat of a phase change material according to an embodiment of the present disclosure.

FIG. 4 is a diagram illustrating that some components of the fire protection apparatus for a battery system using latent heat of a phase change material according to an embodiment of the present disclosure are separated.

### DETAILED DESCRIPTION

Additional objects, features, and advantages of the present disclosure will be understood more clearly from the following detailed description and the accompanying drawings.

Prior to the detailed description of the present disclosure, the present disclosure may be variously modified and may have various embodiments, and it should be understood that examples to be described below and illustrated in the drawings is not intended to limit the present disclosure to specific embodiments and include all modifications, equivalents, and substitutes included in the spirit and technical range of the present disclosure.

It will be understood that when an element is referred to as being “connected” or “coupled” to another element, it can be directly connected or coupled to the other element or intervening elements may be present therebetween. In contrast, when an element is referred to as being “directly connected” or “directly coupled” to another element, there are no intervening elements therebetween.

The terminology used herein is for the purpose of describing particular embodiments only and is not intended to limit the disclosure. As used herein, the singular forms “a”, “an” and “the” include the plural forms as well, unless the context clearly indicates otherwise. It will be further understood that the terms “comprises”, “comprising,”, “includes” and/or “including”, when used herein, specify the presence of stated features, numbers, steps, operations, elements, components, or combinations thereof, but do not preclude the presence or addition of one or more other features, numbers, steps, operations, elements, components, or combinations thereof.

Furthermore, a term such as “ . . . section”, “ . . . unit”, and “ . . . module” described in this specification means a unit for processing at least one function or operation, and this may be implemented with hardware, software, or a combination of the hardware and the software.

Furthermore, in the following description with reference to the accompanying drawings, the same reference numerals are given to the same components and a redundant description thereof will be omitted. Detailed descriptions related to well-known functions or configurations will be ruled out in order not to unnecessarily obscure subject matters of the present disclosure.

Throughout the specification, when a step is “on” or “before” another step, this includes the same right not only when one step is in a direct time series relationship with another, but also when it is in an indirect time series relationship where the order of two steps can be changed, such as a mixing step after each step.

Hereinafter, a fire protection apparatus for a battery system using latent heat of a phase change material and a battery system including the same according to preferred embodiments of the present disclosure are described in detail with reference to the accompanying drawings.

Hereinafter, in the description of the fire protection apparatus for a battery system using latent heat of a phase change material according to an embodiment of the present disclosure, a battery system has a meaning including all cases in which a plurality of batteries, such as a battery module, a battery pack, and a battery rack, is adjacently constructed.

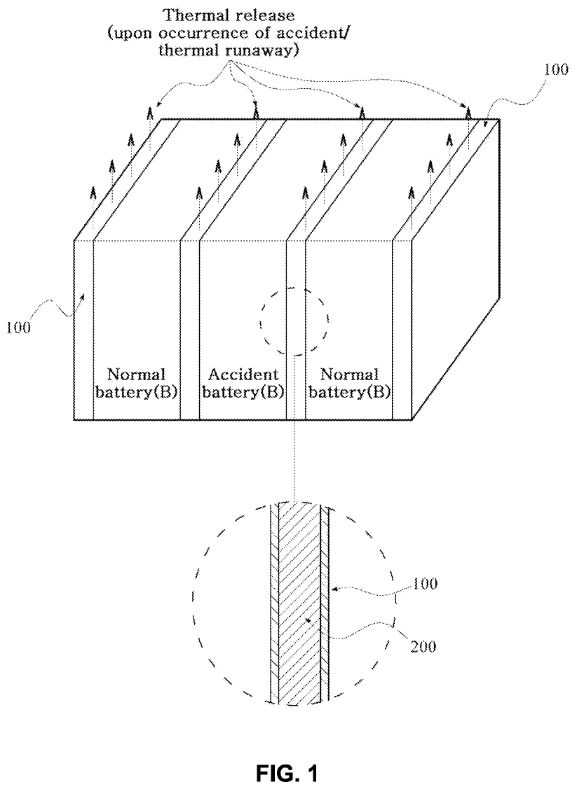

First, a fire protection apparatus for a battery system using latent heat of a phase change material according to a first embodiment of the present disclosure is described in detail with reference to FIG. 1.

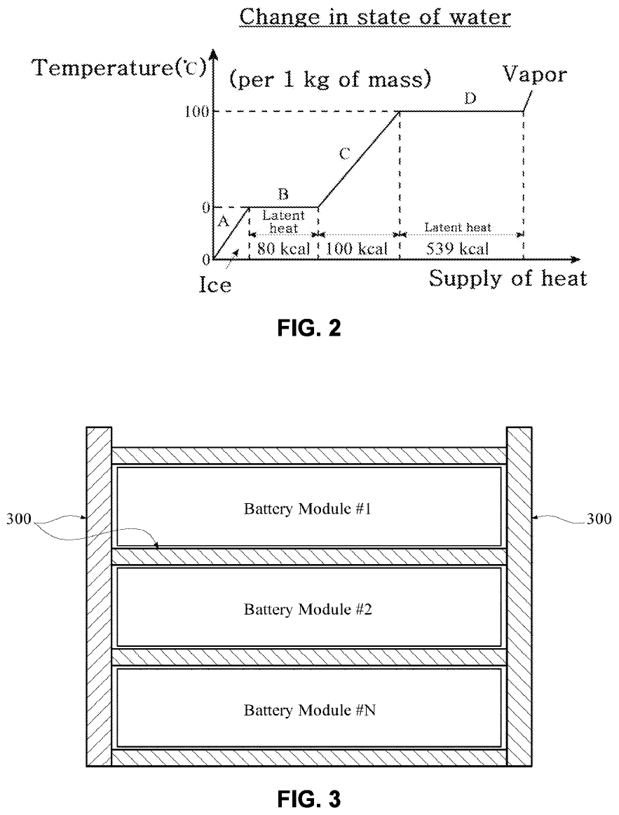

FIG. 1 is a diagram schematically illustrating the fire protection apparatus for a battery system using latent heat of a phase change material according to the first embodiment of the present disclosure. FIG. 2 is a graph illustrating a change in the state of water, that is, a phase change material, as heat absorption-heat dissipation means in the fire protection apparatus for a battery system using latent heat of a phase change material according to an embodiment of the present disclosure.

The fire protection apparatus for a battery system using latent heat of a phase change material according to the first embodiment of the present disclosure is a fire protection apparatus for preventing a fire attributable to the thermal runaway of a battery in a battery system in which two or more batteries are adjacently constructed, and basically includes a partition wall 100 and heat absorption-heat dissipation means 200 as illustrated in FIG. 1.

Specifically, the fire protection apparatus for a battery system using latent heat of a phase change material according to the first embodiment of the present disclosure is a fire protection apparatus for preventing a fire attributable to the thermal runaway of a battery in a battery system in which two or more batteries are adjacently constructed. As illustrated in FIG. 1, the fire protection apparatus includes the partition wall 100 configured to partition batteries B and to have an accommodation space filled with the heat absorption-heat dissipation means 200 therein and configured so that the entire space in which the batteries B are installed is partitioned and isolated from the outside, and the heat absorption-heat dissipation means 200 provided in the accommodation space within the partition wall 100 and configured to absorb and discharge heat attributable to the thermal runaway of an accident battery.

The partition wall 100 may be constructed to have a shape or structure of the battery B that constitutes the battery system or a form or shape according to an arrangement relation thereof.

Furthermore, it is preferred that all of the partition walls 100 are constructed in a way to communicate with one another and are implemented in a fixed type. That is, if the partition wall 100 has a movable structure, the partition wall 100 may be vulnerable to a natural disaster, such as an earthquake.

The partition wall 100 may consist of a plurality of partition walls that individually surrounds the batteries B that constitute the battery system.

It is preferred that the partition wall 100 is made of a material that has thermal conductivity and has low electrical conductivity, for example, an aluminum material.

A plurality of heat dissipation pins may be formed on an external surface of the partition wall 100 in order to increase a heat absorption area and/or a heat dissipation area. In other words, first heat dissipation pins may be formed on the external surface and/or internal surface of the partition wall 100 toward the battery B. Second heat dissipation pins may be formed on the external surface and/or internal surface of the partition wall 100 toward the outside.

Furthermore, the partition wall 100 may further include one or more internal partition members (not illustrated) that partition the inside of the partition wall and also make partition spaces communicate with one another. Charging densities of the heat absorption-heat dissipation means 200 between a partition space toward the battery side and a partition space toward the outside may be different from each other in a partition space partitioned by the internal partition member.

The heat absorption-heat dissipation means 200 is made of a phase change material (PCM), but is made of a phase change material the phase of which is changed at a temperature less than a critical temperature for thermal runaway.

In an embodiment of the present disclosure, it is preferred that the phase change material of the heat absorption-heat dissipation means 200 is at least any one of water (H₂0), a mixture of water, an antifreezing solution, and a mixture of an antifreezing solution or a mixture thereof

As illustrated in FIG. 2, in the case of water, when sensible heat and latent heat are compared, the temperature of evaporation heat is very high, that is, five times or more the sensible heat. If such a principle is used, a lot of thermal energy can be absorbed and discharged. That is, absorbed heat appears as sensible heat within a constant range and performs a heat dissipation function through conduction and convection. However, if heat having a specific level or higher is absorbed, the heat is evaporated (vapor) and is discharged in the form of latent heat safely and rapidly. Accordingly, a surrounding (internal) temperature rise attributable to the generation of heat of an accident battery can be suppressed, and a secondary accident of a normal battery and a surrounding facility can also be prevented.

Furthermore, if water is adopted as the phase change material, water can be easily obtained. A mixture (e.g., an antifreezing solution) for increasing the heat absorption and heat dissipation function may be added to water. Furthermore, if water is adopted as the phase change material, water is economical because water can be reused even after an accident occurs, water is eco-friendly because water does not cause a secondary contamination, and water is economical because maintenance and a repair thereof are very simple.

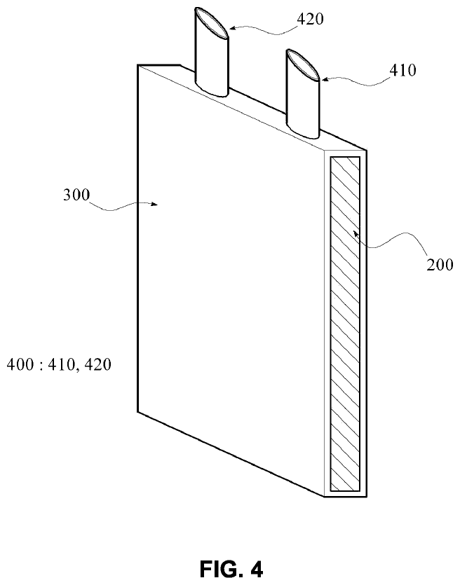

A fire protection apparatus for a battery system using latent heat of a phase change material according to a second embodiment of the present disclosure is described in detail with reference to FIGS. 3 and 4.

FIG. 3 is a diagram schematically illustrating another embodiment of the fire protection apparatus for a battery system using latent heat of a phase change material according to an embodiment of the present disclosure. FIG. 4 is a diagram illustrating that some components of the fire protection apparatus for a battery system using latent heat of a phase change material according to an embodiment of the present disclosure are separated.

The fire protection apparatus for a battery system using latent heat of a phase change material according to the second embodiment of the present disclosure, which is described below, is different from the fire protection apparatus according to the first embodiment in terms of a construction capable of circulating the phase change material. In the description of the fire protection apparatus for a battery system using latent heat of a phase change material according to the second embodiment, the same components as those in the first embodiment are assigned the same reference numerals.

The fire protection apparatus for a battery system using latent heat of a phase change material according to the second embodiment of the present disclosure is a fire protection apparatus for a battery system using latent heat of a phase change material of a battery in a battery system in which two or more batteries are adjacently constructed, and basically includes a partition wall 300, heat absorption-heat dissipation means 200, and a heat absorption-heat dissipation means inflow and outflow device 400, as illustrated in FIGS. 3 and 4.

Specifically, the fire protection apparatus for a battery system using latent heat of a phase change material according to the second embodiment of the present disclosure is a fire protection apparatus for a battery system using latent heat of a phase change material in a battery system in which two or more batteries are adjacently constructed, and includes a partition wall 300 configured to partition batteries B up, down, left and right and to have an accommodation space filled with the absorption-heat dissipation means 200 therein, the heat absorption-heat dissipation means 200 provided in the accommodation space within the partition wall 300 and configured to absorb and discharge heat attributable to the thermal runaway of the accident battery, and the heat absorption-heat dissipation means inflow and outflow device 400 configured to supply the heat absorption-discharge means 200 to an internal space of the partition wall 300 and configured to discharge the heat absorption-discharge means 200 to the outside, as illustrated in FIGS. 3 and 4.

The partition wall 300 may be constructed to have a shape structure of the battery B that constitutes the battery system or a form or shape according to an arrangement relation thereof.

The partition wall 300 may consist of a plurality of partition walls that individually surrounds the batteries B that constitute the battery system.

In this case, it is preferred that all of the partition walls 100 are constructed in a way to communicate with one another and are implemented in a fixed type. That is, if the partition wall 300 has a movable structure, the partition wall 300 may be vulnerable to a natural disaster, such as an earthquake.

Furthermore, as in the first embodiment, it is preferred that the partition wall 300 is made of a material that has thermal conductivity and has low electrical conductivity, for example, an aluminum material.

A plurality of heat dissipation pins may be formed on an external surface of the partition wall 300 in order to increase a heat absorption area and/or a heat dissipation area. In other words, first heat dissipation pins may be formed on the external surface and/or internal surface of the partition wall 300 toward the battery B. Second heat dissipation pins may be formed on the external surface and/or internal surface of the partition wall 300 toward the outside.

The heat absorption-heat dissipation means 200 is made of a phase change material (PCM), but is made of a phase change material the phase of which is changed at a temperature less than a critical temperature for thermal runaway.

In the second embodiment, it is preferred that a phase change material as the heat absorption-heat dissipation means 200 is at least any one of water (H₂O), a mixture of water, an antifreezing solution, and a mixture of an antifreezing solution, or a mixture thereof the phase of which maintains a liquid phase prior to a phase change and is changed into gas heat.

The heat absorption-heat dissipation means inflow and outflow device 400 includes an inlet 410 that is formed on one side of the partition wall 300 at the top thereof or on the one side of the partition wall 300 at an upper part thereof and through which the heat absorption-heat dissipation means 200 is introduced so that the heat absorption-heat dissipation means 200 fills the internal space of the partition wall 300, and an outlet 420 that is formed on the other side of the partition wall 300 at the top thereof or on the other side of the partition wall 300 at an upper thereof and through which the heat absorption-heat dissipation means 200 is discharged.

If the phase change material as the heat absorption-heat dissipation means 200 is water, the internal space is filled with water is filled through the inlet 410. When an accident occurs, the phase change material the phase of which has been changed into steam by heat generated from an accident battery is discharged through the outlet 420.

In this case, a one-way check valve may be provided in each of the inlet 410 and the outlet 420. Specifically, the one-way check valve that may be opened in a direction in which the phase change material is supplied and is closed in a direction opposite to the direction in which the phase change material is supplied may be constructed in the inlet 410. The one-way check valve that may be opened in a direction in which the phase change material is discharged and is closed in a direction opposite to the direction in which the phase change material is discharged may be constructed in the outlet 420.

The heat absorption-heat dissipation means inflow and outflow device 400 may further include a phase change material circulation device unit capable of circulating the phase change material.

The phase change material circulation device unit may include a temperature detection module configured to detect an inside and outside temperature of the partition wall 300, phase change material supply means constructed on one side of the partition wall 300 and configured to supply the phase change material, a circulation outlet formed on one side at the bottom of the partition wall 300 on the other side thereof, a one-way check valve provided in the circulation outlet and opened and closed by control of a controller, and the controller configured to receive a temperature detected by the temperature detection module and to operate the phase change material supply means and the one-way check valve so that the phase change material is supplied through the inlet 410 and the phase change material is discharged through the circulation outlet.

As described above, the phase change material may be made of water. The phase change material supply means may consist of a supply pump, for example, and may pump water or may be connected to a common water supply network and may supply the phase change material to the inside of the partition wall through the inlet by an opening and closing manipulation.

The controller controls the phase change material supply means and the one-way check valve to operate, when the temperature detection module detects that a temperature of the phase change material within the partition wall 300 reaches a preset temperature (i.e., a temperature at which battery thermal runaway occurs).

If the phase change material circulation device unit is further included, steam resulting from the phase change of water by heat, generated from an accident batter, in the case of water as the phase change material is primarily discharged through the outlet 420, thus discharging heat. If a temperature within the battery system rises and reaches a setting temperature (e.g., a critical temperature at which thermal runaway occurs) despite the discharge of the heat through the phase change of the phase change material, secondary heat discharge is performed in a way to supply the phase change material having a relatively low temperature by operating the phase change material supply means and the one-way check valve.

In this case, the circulation outlet does not need to be separately constructed. The outlet 420 may be constructed as a single outlet capable of playing a role as the circulation outlet or may be integrally formed with the circulation outlet.

The fire protection apparatus for a battery system using latent heat of a phase change material according to an embodiment of the present disclosure has an advantage in that it can prevent a secondary accident of an adjacent normal battery and a surrounding facility by preventing a fire in a way to suppress a rise in a surrounding temperature, which is attributable to the generation of heat of an accident battery, by effectively absorbing and discharging the heat of the accident battery attributable to thermal runaway.

Furthermore, according to an embodiment of the present disclosure, the fire protection apparatus has advantages in that the fire protection apparatus can serve versatility and economic feasibility because the components for preventing a fire can be constructed relatively simply and a fire attributable to thermal runaway can also be efficiently prevented, the fire protection apparatus can be reused after a fire prevention function is performed, and the fire protection apparatus is economical because maintenance and a repair thereof are simple.

While various embodiments have been described above, it will be understood to those skilled in the art that the embodiments described are by way of example only. Accordingly, the disclosure described herein should not be limited based on the described embodiments.

Although the embodiments as described above have been described with reference to the limited drawings, various technical modifications may be applied based on the above description to a person skilled in the art. For example, appropriate results can be achieved even if the described techniques are performed in a different order than the described method, and/or components, such as systems, structures, devices, circuits, etc., are combined or replaced by other components or equivalents.

The embodiment and the accompanying drawings described in the present specification are merely intended to describe a part of the technical spirit included in the present disclosure. Therefore, since the embodiment disclosed in the present specification is not intended to limit the technical spirit of the present disclosure but to explain the technical spirit of the present disclosure, it is obvious that the scope of the technical spirit of the present disclosure is not limited by such an embodiment. Modifications and specific embodiments easily inferred by those skilled in the art within the scope of the technical spirit included in the specification and the drawings of the present disclosure should be construed as being included in the scope of the present disclosure.

What is claimed is:

1. A fire protection apparatus for a battery system for preventing a fire by using latent heat of a phase change material in a battery system in which two or more batteries are adjacently constructed, the fire protection apparatus comprising:
partition walls configured to partition batteries, each formed to have an accommodation space filled with heat absorption-heat dissipation means therein, and configured so that an entire space in which the batteries are installed is partitioned and isolated from an outside; and
the heat absorption-heat dissipation means provided in the accommodation space of the partition wall and configured to absorb and discharge heat attributable to thermal runaway of an accident battery.

2. The fire protection apparatus of claim 1, wherein:
all of the partition walls are configured to communicate with one another, and
the heat absorption-heat dissipation means is made of a phase change material (PCM) and is made of a material a phase of which is changed at a temperature less than a temperature at which thermal runaway occurs.

3. The fire protection apparatus of claim 2, wherein the heat absorption-heat dissipation means is at least any one of water (H₂O), a mixture of water, an antifreezing solution, and a mixture thereof.

4. The fire protection apparatus of claim 1, further comprising a heat absorption-heat dissipation means inflow and outflow device configured to supply the heat absorption-discharge means to an internal space of the partition wall and to discharge the heat absorption-discharge means to an outside.

5. The fire protection apparatus of claim 4, wherein the heat absorption-heat dissipation means inflow and outflow device comprises:
an inlet formed on one side of the partition wall at an upper part thereof and through which the heat absorption-heat dissipation means is introduced; and
an outlet formed on the other side of the partition wall at an upper part thereof and through which the heat absorption-heat dissipation means is discharged.

6. The fire protection apparatus of claim 5, further comprising:
a temperature detection module configured to detect an inside and outside temperature of the partition wall;
phase change material supply means configured to supply a phase change material through the inlet;
a circulation outlet formed on one side at a bottom of the partition wall on the other side thereof;
a one-way check valve provided in each of the inlet and the circulation outlet and opened and closed by control of a controller; and
the controller configured to receive a temperature detected by the temperature detection module and to operate the phase change material supply means and the one-way check valve so that the phase change material is supplied through the inlet and the phase change material is discharged through the circulation outlet.

7. The fire protection apparatus of claim 6, wherein the outlet and the circulation outlet are integrally formed.

8. A battery system comprising the fire protection apparatus for a battery system according to claim 1.
